(19) United States
(12) Patent Application Publication
(10) Pub. No.: US 2026/0367652 A1
(43) Pub. Date: Nov. 19, 2026

(54) METHOD AND APPARATUS FOR CONTROLLING VEHICLE

(71) Applicant: HYUNDAI MOBIS CO., LTD., Seoul (KR)

(72) Inventor: A Ra CHOI, Yongin-si (KR)

(73) Assignee: HYUNDAI MOBIS CO., LTD., Seoul (KR)

(21) Appl. No.: 19/446,657

(22) Filed: Jan. 12, 2026

(30) Foreign Application Priority Data
May 16, 2025 (KR) 10-2025-0063985

(51) Int. Cl. G05D 1/81; G05B 13/02; G06V 10/80; G06V 20/52; G06V 20/59; G05D 101/15; G06V 10/774; G06V 10/82

(52) U.S. Cl. CPC G05D 1/81; G05B 13/027; G06V 10/80; G06V 20/52; G06V 20/597; G05D 2101/15; G06V 10/774; G06V 10/82

(57) ABSTRACT

A method of controlling a vehicle according to one embodiment may include performing learning through sensor fusion using at least one weight, determining a level for driving intervention for a user of the vehicle based on an inference probability generated according to the learning, and controlling at least a portion of the vehicle based on the determined level.

### CROSS-REFERENCE TO RELATED APPLICATION

This application claims priority to and the benefit under 35 USC § 119(a) of Korean Patent Application No. 10-2025-0063985, filed on MAY. 16, 2025, in the Korean Intellectual Property Office, the disclosure of which is incorporated herein by reference in its entirety for all purposes.

### BACKGROUND

### 1. FIELD

Embodiments of the present invention relate to a method and apparatus for controlling a vehicle, and more particularly, to a deep learning-linked in-cabin and driving assistance system (DAS) sensor fusion driving assistance system.

### 2. DISCUSSION OF THE RELATED ART

Research on autonomous vehicles, which are vehicles capable of traveling on their own without driver intervention, is actively being conducted.

These vehicles may use advanced technology to perceive their surroundings, determine risks, and plan driving routes on their own, thereby allowing safe operation without any operation by a driver or passenger.

Internationally, autonomous vehicles are classified into several levels, and each level may be distinguished according to a driver’s responsibilities and a system’s role.

At Level 1, the system may provide the driver with warnings, control assistance, and the like, at Level 2, the system may perform driving under specific conditions such as lane keeping assistance, automatic parking, or the like, at Level 3, the system may autonomously drive without driver intervention in specific environments or situations such as highway driving assistance or the like, at Level 4, the system may allow safe traveling on most roads and drive itself without driver intervention, and, at Level 5, the vehicle may safely reach a destination in all situations without a driver.

However, many problems occur in the development of autonomous vehicles, and, to solve these problems, a deep learning-linked in-cabin and driving assistance system (DAS) sensor fusion driving assistance system is suggested.

### SUMMARY

According to an aspect of the present invention, there is provided a method of controlling a vehicle including performing learning through sensor fusion using at least one weight, determining a level for driving intervention for a user of the vehicle based on an inference probability generated according to the learning, and controlling at least a portion of the vehicle based on the determined level.

In the performing of the learning, the learning may be performed by fusing data acquired from an in-cabin sensor and a driving assistance system (DAS) sensor using deep learning.

In the determining, the level may be determined according to a degree of emergency associated with the driving intervention.

In the controlling, a warning or notification may be provided to the user of the vehicle when the determined level is a level indicating emergency intervention.

In the performing of the learning, weight learning may be performed using a convolutional layer and a neural network.

According to another aspect of the present invention, there is provided an apparatus for controlling a vehicle including a sensor fusion learning unit configured to perform learning through sensor fusion using at least one weight, a level determination unit configured to determine a level for driving intervention of a user of the vehicle based on an inference probability generated according to the learning, and a control unit configured to control at least a portion of the vehicle based on the determined level.

The sensor fusion learning unit may perform the learning by fusing data acquired from an in-cabin sensor and a driving assistance system (DAS) sensor and perform the learning using deep learning.

The level determination unit may determine the level according to a degree of emergency associated with the driving intervention.

The control unit may provide a warning or notification to the user of the vehicle when the determined level is a level indicating emergency intervention.

The sensor fusion learning unit may perform weight learning using a convolutional layer and a neural network.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a flowchart of a method of controlling a vehicle according to one embodiment;

FIG. 2 is a view illustrating a method of controlling a vehicle using sensor fusion according to one embodiment;

FIG. 3 is a diagram illustrating deep learning-based driver image augmentation according to one embodiment;

FIG. 4 is a diagram illustrating fusion learning of deep learning-based in-cabin sensor and driving assistance system (DAS) sensor data according to one embodiment;

FIG. 5 is a diagram illustrating subdivision and active determination of driver driving intervention levels as a result of the fusion learning of deep learning-based in-cabin sensor and DAS sensor data according to one embodiment;

FIG. 6 is a diagram illustrating the method of controlling a vehicle according to one embodiment; and

FIG. 7 is a block diagram of an apparatus for controlling a vehicle according to one embodiment.

### DETAILED DESCRIPTION

Hereinafter, preferred embodiments of the present invention will be described in detail with reference to the accompanying drawings.

However, the technical idea of the present invention is not limited to some embodiments to be described but may be implemented in various different forms, and within the scope of the technical idea of the present invention, one or more among components in the embodiments may be used by being selectively combined and substituted.

Further, unless specifically defined and described, terms used in the embodiments of the present invention (including technical and scientific terms) may be interpreted as meanings which are generally understood by those skilled in the art to which the present invention pertains, and commonly used terms such as terms defined in dictionaries may be interpreted in consideration of the contextual meaning of the related art.

Terms used in the embodiments of the present invention are for the purpose of describing the embodiments only and are not intended to limit the invention.

In the present specification, the singular forms may include the plural forms unless the context clearly dictates otherwise, and when described as “at least one (or one or more) among A, B, and (or) C,” it may include one or more of all possible combinations of A, B, and C.

In addition, when describing components of embodiments of the present invention, terms such as first, second, A, B, (a), (b), etc., may be used.

These terms are only for distinguishing the components from other components, and the essence, sequence, or order of the components is not limited by these terms.

In addition, when a component is described as being “linked,” “coupled,” or “connected” to another component, the component is not only directly linked, coupled, or connected to another component, but also “linked,” “coupled,” or “connected” to another component with still another component disposed between the component and the other component.

Further, when a component is described as being formed or disposed “on (above) or under (below)” another component, the term “on (above) or under (below)” includes not only when two components are in direct contact with each other, but also when one or more other components are formed or disposed between the two components. Further, when a component is described as being “on (above) or below (under),” the description may include the meanings of an upward direction and a downward direction based on one component.

Hereinafter, embodiments will be described in detail with reference to the accompanying drawings, but the same or corresponding components are denoted by the same reference numerals regardless of the drawing numbers, and redundant descriptions thereof will be omitted.

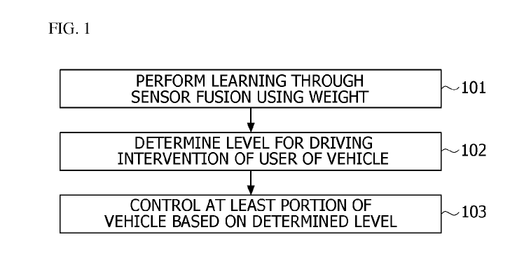

FIG. 1 is a flowchart of a method of controlling a vehicle according to one embodiment.

According to one embodiment, each operation of the method of controlling a vehicle may be performed by at least some of components of an apparatus for controlling the vehicle, which will be described below.

According to one embodiment, components of the apparatus for controlling the vehicle may be configured to include at least some of a vehicle, a machine, a circuit, a semiconductor, a computing device, a memory, a processor, a data transceiver, and the like, and at least a portion of each component may be mechanically/physically/communicatively/electrically connected to at least a portion of another component.

According to one embodiment, components of the apparatus for controlling the vehicle may include at least some of all components of the specification or drawings, and the components of the apparatus for controlling the vehicle may perform at least some of all operations or functions of the specification or drawings.

According to one embodiment, components of the apparatus for controlling the vehicle may output/display at least some of all components of the specification or drawings through a display, a speaker, a user terminal, or the like. The user terminal may include at least a portion of a mobile device or a computing device.

In operation 101, the apparatus for controlling the vehicle may perform learning through sensor fusion using weights.

According to one embodiment, the apparatus for controlling the vehicle may perform learning by fusing data acquired from an in-cabin sensor and a driving assistance system (DAS) sensor using deep learning.

According to one embodiment, the apparatus for controlling the vehicle may perform weight learning using a convolutional layer and a neural network.

In operation 102, the apparatus for controlling the vehicle may determine a level for driving intervention for a user of the vehicle based on the inference probability according to the learning.

According to one embodiment, the apparatus for controlling the vehicle may determine the level depending on the degree of emergency of driving intervention for the user.

In operation 103, the apparatus for controlling the vehicle may control at least a portion of the vehicle based on the determined level.

According to one embodiment, the apparatus for controlling the vehicle may control at least a portion of the vehicle by using/transferring/transmitting a control command, a control signal, or the like.

According to one embodiment, the apparatus for controlling the vehicle may provide a warning or notification to the user of the vehicle when the determined level is a level that requests emergency intervention.

According to one embodiment, the apparatus for controlling the vehicle may output/transfer/transmit a warning or notification indicating an emergency intervention request depending on the level at which the emergency intervention is requested.

According to one embodiment, the apparatus for controlling the vehicle has the advantage of being able to subdivide levels of DAS driving assistance control based on driver inattention and levels of driver driving intervention and actively determine a level in an autonomous driving emergency situation.

According to one embodiment, the apparatus for controlling the vehicle may have the effect of being able to make fast and effective determinations in various situations using weights learned based on labeling of various driver inattention images and vehicle data, rather than performing mathematical modeling.

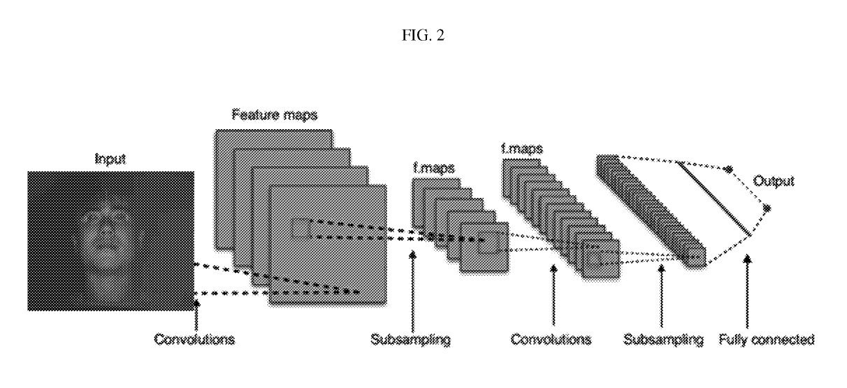

FIG. 2 is a view illustrating a method of controlling a vehicle using sensor fusion according to one embodiment.

According to one embodiment, an apparatus for controlling the vehicle may provide a driving assistance system capable of improving driver stability through deep learning-based fusion of data of an in-cabin sensor and a DAS sensor.

According to one embodiment, the apparatus for controlling the vehicle may provide/use a method of subdividing levels of DAS driving assistance through deep learning-based learning of driver front-view inattention and driving patterns in a situation where driver driving intervention levels are subdivided and actively determined in an autonomous driving (e.g., Lv3) emergency situation.

According to one embodiment, the apparatus for controlling the vehicle may utilize/use various open-source software (OpenSW) in the case of learning techniques, and may specify labeling methods for driver images and vehicle learning data in data learning.

According to one embodiment, the apparatus for controlling the vehicle may train a (AI) model using information/data acquired from a driver monitoring system (ICC) equipped with an IR camera (mounted on the vehicle) and a DAS equipped with DAS sensors (e.g., a lidar, a camera, and the like).

According to one embodiment, the apparatus for controlling the vehicle may perform sensor fusion based on/using driver determination information acquired from the in-vehicle IR camera and determination information based on the DAS sensor based on deep learning, and may subdivide driver driving intervention levels based on a result of the sensor fusion and actively determine a level based on/using a generated/trained model when a request for driver intervention in autonomous driving (e.g., Lv3) occurs.

According to one embodiment, a labeling list may include driver inattention information, DAS driving assistance information, vehicle information, and the like.

According to one embodiment, the apparatus for controlling the vehicle may perform learning utilizing/using the labeling list.

According to one embodiment, the driver inattention information, the DAS driving assistance information, and the vehicle information may include all available video/images, text, and the like acquired from the vehicle or a driver monitoring system (ICC) and the DAS, and may be used as input data for training.

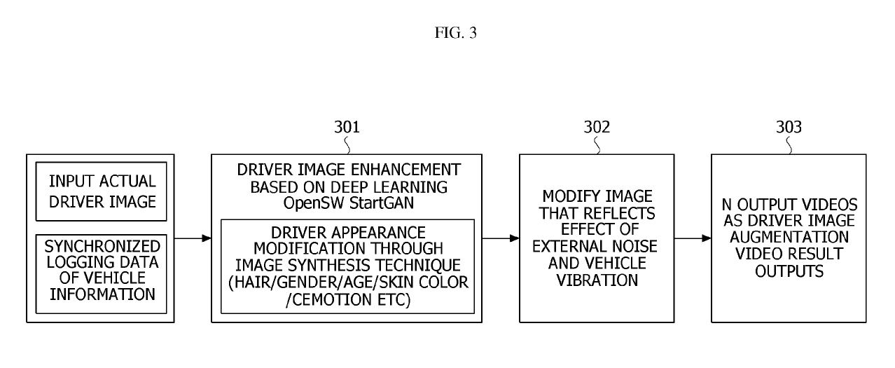

FIG. 3 is a diagram illustrating deep learning-based driver image augmentation according to one embodiment.

According to one embodiment, an apparatus for controlling a vehicle may perform driver image enhancement based on a deep learning OpenSW startGAN based on synchronized logging data of actual driver images and the vehicle information, and may perform driver appearance modification through an image synthesis technique (301).

According to one embodiment, the apparatus for controlling the vehicle may modify an image into an image that reflects the effects of vehicle vibration and external noise (302).

According to one embodiment, the apparatus for controlling the vehicle may generate/provide N output videos as driver image augmentation video result outputs (303).

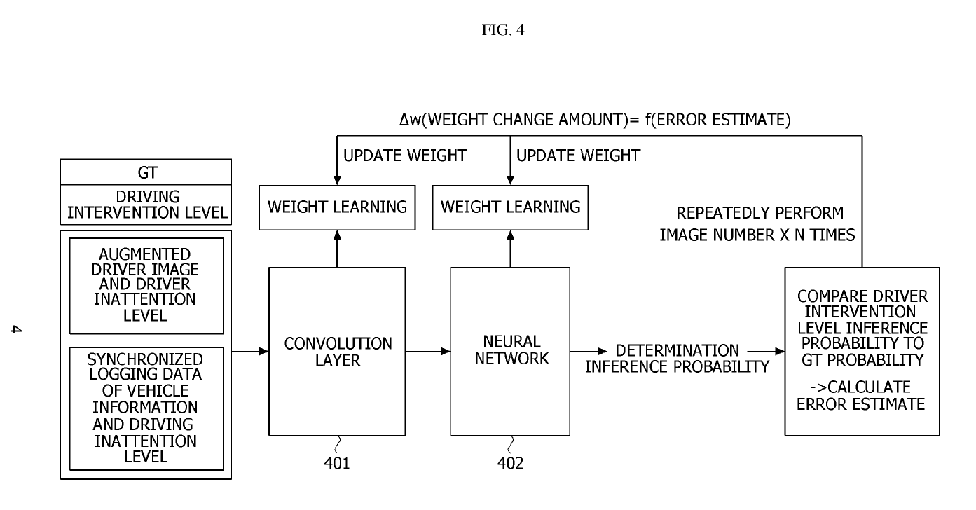

FIG. 4 is a diagram illustrating fusion learning of deep learning-based in-cabin sensor and driving assistance system (DAS) sensor data according to one embodiment.

According to one embodiment, an apparatus for controlling a vehicle may perform weight learning using a convolution layer 401 based on an augmented driver image and a driver inattention level and synchronized logging data of vehicle information and a driving inattention level, and the weights may be updated. A weight change amount may be calculated/produced as a function that uses an error estimate as a parameter.

According to one embodiment, the apparatus for controlling the vehicle may perform weight learning using a neural network 402 based on information/results acquired from the convolution layer 401, and a determination inference probability may be derived/produced.

According to one embodiment, the apparatus for controlling the vehicle may produce/calculate the error estimate by comparing probabilities.

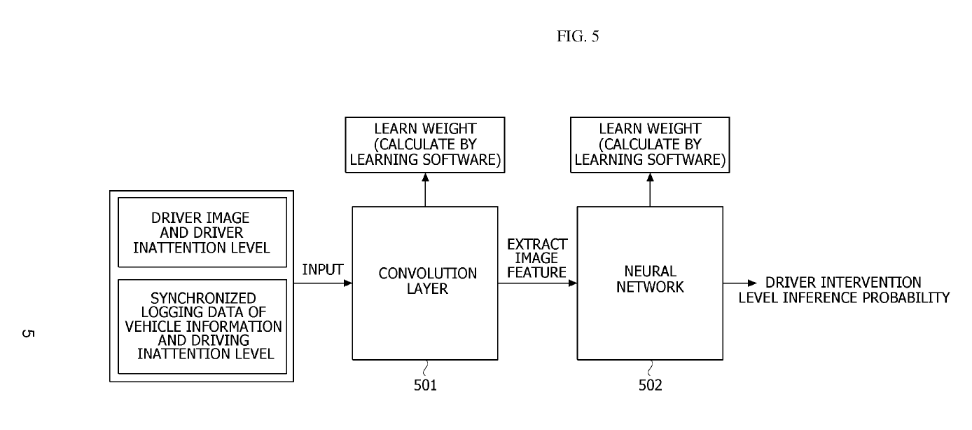

FIG. 5 is a diagram illustrating subdivision and active determination of driver driving intervention levels as a result of the fusion learning of deep learning-based in-cabin sensor and DAS sensor data according to one embodiment.

According to one embodiment, an apparatus for controlling a vehicle may perform weight learning using a convolution layer 501 using a driver image and a driver inattention level and synchronized logging data of vehicle information and a driving inattention level as input data, and the weights may be updated.

According to one embodiment, the apparatus for controlling the vehicle may perform weight learning using a neural network 502, using image feature extraction with information/results acquired from the convolution layer 501, and a driver intervention level inference probability may be produced/calculated.

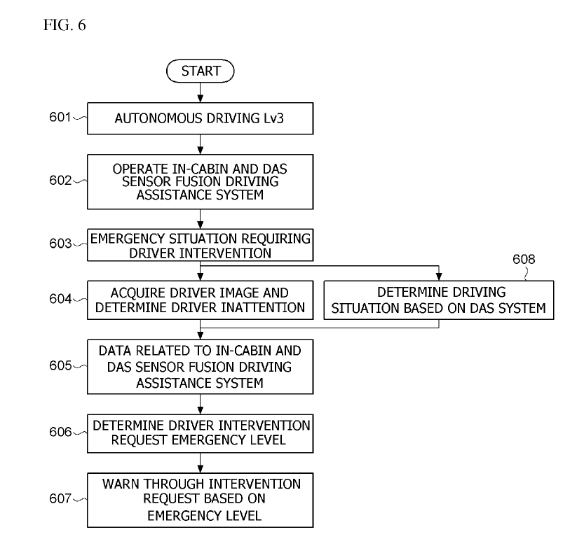

FIG. 6 is a diagram illustrating a method of controlling a vehicle according to one embodiment.

In operation 601, an apparatus for controlling a vehicle may check whether autonomous driving is possible or check a state (e.g., Lv3).

In operation 602, the apparatus for controlling the vehicle may operate as an in-cabin and DAS sensor fusion driving assistance system.

In operation 603, the apparatus for controlling the vehicle may check whether an emergency situation requiring driver intervention occurs.

According to one embodiment, the apparatus for controlling the vehicle may use sensors disposed within the vehicle to check whether an emergency situation requiring driver intervention occurs.

In operation 604, the apparatus for controlling the vehicle may acquire a driver image and determine driver inattention.

In operation 605, the apparatus for controlling the vehicle may receive data related to the in-cabin and DAS sensor fusion driving assistance system.

In operation 606, the apparatus for controlling the vehicle may determine a driver intervention request emergency level.

In operation 607, the apparatus for controlling the vehicle may perform warning through an intervention request based on the emergency level.

In operation 608, the apparatus for controlling the vehicle may determine a driving situation based on the DAS system.

According to one embodiment, the apparatus for controlling the vehicle may perform an active determination by subdividing levels of driver driving intervention in the emergency situation during autonomous driving such as Lv3.

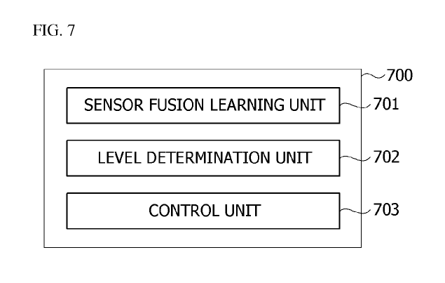

FIG. 7 is a block diagram of an apparatus for controlling a vehicle according to one embodiment.

According to one embodiment, an apparatus 700 for controlling a vehicle may include a sensor fusion learning unit 701 that performs learning through sensor fusion using weights, a level determination unit 702 that determines a level for driving intervention of a user of the vehicle based on an inference probability according to the learning, and a control unit 703 that controls at least a portion of the vehicle based on the determined level.

According to one embodiment, the sensor fusion learning unit 701 may perform the learning by fusing data acquired from an in-cabin sensor and a DAS sensor and perform learning using deep learning.

According to one embodiment, the level determination unit 702 may determine the level depending on the degree of emergency of driving intervention for the user.

According to one embodiment, the control unit 703 may provide a warning or notification to the user of the vehicle when the determined level is a level that requests emergency intervention.

According to one embodiment, the sensor fusion learning unit 701 may perform weight learning using a convolutional layer and a neural network.

According to one embodiment, the apparatus for controlling the vehicle has the advantage of being able to quickly determine the weights learned based on a driver inattention image captured using an in-cabin camera and labeled vehicle data in various situations.

The term “~unit” used in the present embodiment refers to software components or hardware components such as a field-programmable gate array (FPGA) or an application specific integrated circuit (ASIC), and “~unit” performs certain functions. However, the “~unit” is not limited to software or hardware. The “~unit” may be configured to reside in an addressable storage medium, or may be configured to reproduce one or more processors. Therefore, for example, “~unit” includes components such as software components, object-oriented software components, class components, and task components, and includes processes, functions, attributes, procedures, sub-routines, segments of program code, drivers, firmware, micro codes, circuits, data, a database, data structures, tables, arrays, and variables. Functions provided in the components and the “~unit” may be combined into smaller numbers of components and “~units,” or may be further divided into additional components and “~units.” Furthermore, the components and “~units” may be implemented to reproduce one or more CPUs in a device or a security multimedia card.

Although the preferred embodiments of the present invention have been described above, it is understood that those skilled in the art can make various changes and modifications to the present invention without departing from the spirit and scope of the present invention set forth in the claims below.

What is claimed is:

1. A method of controlling a vehicle, comprising:
performing learning through sensor fusion using at least one weight;
determining a level for driving intervention for a user of the vehicle based on an inference probability generated according to the learning; and
controlling at least a portion of the vehicle based on the determined level.

2. The method of claim 1, wherein, in the performing of the learning, the learning is performed by fusing data acquired from an in-cabin sensor and a driving assistance system (DAS) sensor using deep learning.

3. The method of claim 1, wherein, in the determining, the level is determined based on a degree of emergency associated with the driving intervention.

4. The method of claim 3, wherein, in the controlling, a warning or notification is provided to the user of the vehicle when the determined level is a level indicating emergency intervention.

5. The method of claim 1, wherein, in the performing of the learning, weight learning is performed using a convolutional layer and a neural network.

6. An apparatus for controlling a vehicle, comprising:
a sensor fusion learning unit configured to perform learning through sensor fusion using at least one weight;
a level determination unit configured to determine a level for driving intervention of a user of the vehicle based on an inference probability generated according to the learning; and
a control unit configured to control at least a portion of the vehicle based on the determined level.

7. The apparatus of claim 6, wherein the sensor fusion learning unit performs the learning by fusing data acquired from an in-cabin sensor and a driving assistance system (DAS) sensor and performs the learning using deep learning.

8. The apparatus of claim 6, wherein the level determination unit determines the level according to a degree of emergency associated with the driving intervention.

9. The apparatus of claim 8, wherein the control unit provides a warning or notification to the user of the vehicle when the determined level is a level indicating emergency intervention.

10. The apparatus of claim 6, wherein the sensor fusion learning unit performs weight learning using a convolutional layer and a neural network.
